(19) United States
(12) Patent Application Publication
(10) Pub. No.: US 2009/0156062 A1
(43) Pub. Date: Jun. 18, 2009

(54) NON-MECHANICAL MEANS FOR CONNECTOR POLARIZATION FOR A LIGHTING SYSTEM

(76) Inventors: Daniel P. Reed, Warren, MI (US); Matthew Mark Mikolajczak, Novi, MI (US)

Correspondence Address: FRASER CLEMENS MARTIN & MILLER LLC, 28366 KENSINGTON LANE, PERRYSBURG, OH, 43551, US

(21) Appl. No.: 11/955,531

(22) Filed: Dec. 13, 2007

(51) Int. Cl. H01R 13/64

(52) U.S. Cl. 439/677; 315/201

(57) ABSTRACT

A lighting system and method for connector polarization, wherein the lighting system includes a lighting module having a substrate, a light source disposed on the substrate, a first connector adapted to provide electrical communication with a source of electrical energy, a conductive path including a supply path and a plurality of return paths, the conductive path providing electrical communication between the light source and the connector, and a diode disposed in at least one of the return paths, wherein the diode militates against a current flowing in an undesirable direction; and a controller having a second connector adapted to provide electrical communication with the lighting module.

### FIELD OF THE INVENTION

The present invention relates to a lighting system. More particularly, the invention is directed to a non-mechanical means for connector polarization for a lighting system.

### BACKGROUND OF THE INVENTION

Currently, for a string of light sources with multiple break points, polarized connectors are utilized to ensure a proper connection of electrical circuits. Unique connectors are coupled at each break point in the circuit to prevent improper connection. Typically the connectors have multiple locations for a polarization rib to physically limit interconnects from occurring. Manufacturing unique connectors according to the prior art is costly and inefficient.

It would be desirable to have a non-mechanical means for connector polarization for a lighting system and a method for polarized connection, wherein the connection provides a simple and inexpensive means for electrical communication between a source of electrical energy and a light source.

### SUMMARY OF THE INVENTION

Concordant and consistent with the present invention, a non-mechanical means for connector polarization for a lighting system and a method for polarized connection, wherein the connection provides a simple and inexpensive means for electrical communication between a source of electrical energy and a light source, has surprisingly been discovered.

In one embodiment, a lighting module comprises a substrate, a light source disposed on the substrate, a connector adapted to provide electrical communication with a source of electrical energy, a conductive path disposed in the substrate and including a supply path and a plurality of return paths, the conductive path providing electrical communication between the light source and the connector, and a diode disposed in at least one of the return paths, wherein the diode militates against a current flowing in an undesirable direction.

In another embodiment, a lighting system comprises a lighting module including a substrate, a light source disposed on the substrate, a first connector adapted to provide electrical communication with a source of electrical energy, a conductive path including a supply path and a plurality of return paths, the conductive path providing electrical communication between the light source and the connector, and a diode disposed in at least one of the return paths, wherein the diode militates against a current flowing in an undesirable direction, and a controller having a second connector adapted to provide electrical communication with the lighting module.

The invention also provides methods for connector polarization.

One method comprises the steps of providing a first lighting module including a substrate, a light source disposed on the substrate, a first connector adapted to provide electrical communication with a second lighting module, a conductive path including a supply path and a plurality of return paths, the conductive path providing electrical communication between the light source and the connector, and a diode disposed in at least one of the return paths, wherein the diode militates against a current flowing in an undesirable direction; providing a second lighting module including a substrate, a light source disposed on the substrate, a second connector adapted to provide electrical communication with the first connector of the first lighting module, a third connector adapted to provide electrical communication with a controller, a plurality of conductive paths including a supply path and a plurality of return paths, the conductive paths providing electrical communication between the light source and the second and third connectors; providing a controller having a fourth connector adapted to provide electrical communication with the third connector of the second lighting module; coupling the first connector and the second connector; and coupling the third connector and the fourth connector, wherein the controller is in electrical communication with the first lighting module and the second lighting module.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic view of a properly connected lighting system according to an embodiment of the present invention; and

FIG. 2 is a schematic view of an improperly connected lighting system according to the embodiment shown in FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

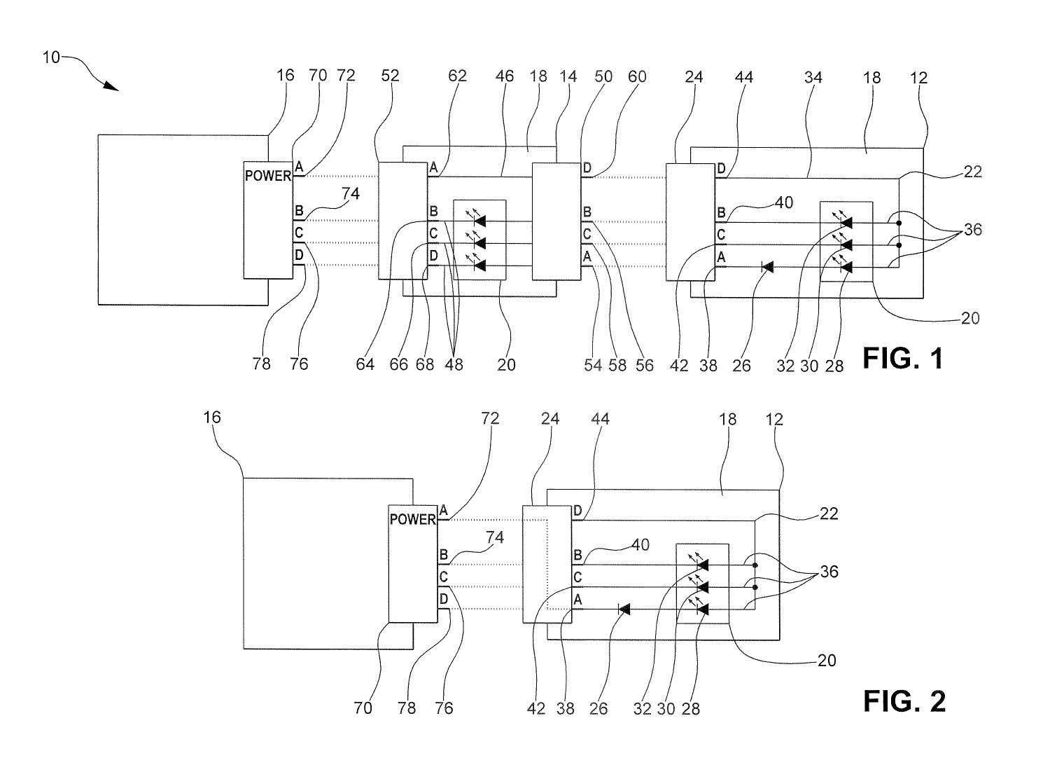

FIG. 1 illustrates a lighting system 10 according to an embodiment of the present invention. The lighting system 10 includes a first lighting module 12, a second lighting module 14, and a controller 16. It is understood that the lighting system 10 may have any number of lighting modules, as desired.

The first lighting module 12 includes a substrate 18, a light source 20, a conductive path 22, a first connector 24, and a diode 26. It is understood that the first lighting module 12 may include any conventional housing for protection such as a transparent tubing and a clear plastic housing, for example. The substrate 18 may be formed from any conventional material such as a printed circuit board, for example.

As shown, the light source 20 is a tri-color light emitting diode (LED) package having a red LED 28, a green LED 30, and a blue LED 32. It is understood that the light source 20 may be any conventional light source 20 such as a single LED package, for example.

The conductive path 22 may be formed from any conventional conductive material such as metal, for example. As shown, the conductive path 22 includes a first lighting module supply path 34 and three separate first lighting module return paths 36. It is understood that the conductive path 22 may include any number of supply and return paths, as desired.

The first connector 24 is shown as a four pin female connector having a first connector first pin-out 38, a first connector second pin-out 40, a first connector third pin-out 42, and a first connector fourth pin-out pin 44, adapted to provide electrical communication with a source of electrical energy. It is understood that the first connector 24 may be any conventional connector for providing electrical communication and may further include an internal circuit for routing an electrical current to the conductive path 22. As shown, the first connector first pin-out 38 is in electrical communication with the first lighting module return path 36 of the red LED 28; the first connector second pin-out 40 is in electrical communication with the first lighting module return path 36 of the blue LED 32; the first connector third pin-out 42 is in electrical communication with the first lighting module return path 36 of the green LED 30; and the first connector fourth pin-out 44 is in electrical communication with the first lighting module supply path 34. It is understood that the first connector 24 may have any pin-out configuration, as desired.

As shown, the diode 26 is disposed in the first lighting module return path 36 of the red LED 28. It is understood that any number of diodes may be disposed on any of the return paths 36, as desired. Diodes may also be disposed on any number of return paths 36.

The second lighting module 14 includes a substrate 18, a light source 20, a second lighting module supply path 46, a plurality of second lighting module return paths 48, a second connector 50, and a third connector 52. It is understood that the second lighting module 14 may include any conventional housing for protection such as a transparent tubing and a clear plastic housing, for example. The substrate 18 may be formed from and conventional substrate 18 material such as a printed circuit board, for example.

As shown, the light source 20 is a tri-color light emitting diode (LED) package having a red LED 28, a green LED 30, and a blue LED 32. It is understood that the light source 20 may be any conventional light source 20 such as a single color LED package, for example.

The second lighting module supply path 46 may be formed from any conventional conductive material such as metal, for example. The second lighting module return paths 48 may be formed from any conventional conductive material such as metal, for example. It is understood that the second lighting module 14 may include any number of supply and return paths, as desired.

The second connector 50 is shown as a four pin male connector having a first pin-out 54, a second pin-out 56, a third pin-out 58, and a fourth pin-out 60. The second connector 50 is adapted to provide electrical communication with the first connector 24. It is understood that the second connector 24 may be any conventional connector for providing electrical communication and may further include an internal circuit for routing an electrical current from the second lighting module supply path 46 and the second lighting module return paths 48. As shown, the second connector first pin-out 54 is in electrical communication with the first connector first pin-out 38; the second connector second pin-out 56 is in electrical communication with the first connector second pin-out 40; the second connector third pin-out 58 is in electrical communication with the first connector third pin-out 42; and the second connector fourth pin-out 60 in electrical communication with the first connector fourth pin-out 44. It is understood that the second connector 14 may have any pin-out configuration, as desired.

The third connector 52 is shown as a four pin female connector having a first pin-out 62, a second pin-out 64, a third pin-out 66, and a fourth pin-out 68, adapted to provide electrical communication with a source of electrical energy. It is understood that the third connector 52 may be any conventional connector for providing electrical communication and may further include an internal circuit for routing an electrical current to the second lighting module supply path 46 and the second lighting module return paths 48. As shown, the third connector first pin-out 62 is in electrical communication with the second lighting module supply path 46; the third connector second pin-out 64 is in electrical communication with the second lighting module return path 48 of the blue LED 32; the third connector third pin-out 66 is in electrical communication with the second lighting module return path 48 of the green LED 30; and the third connector fourth pin-out 68 is in electrical communication with the second lighting module return path 48 of the red LED 28. It is understood that the third connector 52 may have any pin-out configuration, as desired.

The controller 16 may be any conventional controller such as a computer controller and an LED driver, for example. The controller 16 includes a fourth connector 70 adapted to provide electrical communication with the 52 third connector. The fourth connector 70 is shown as a four pin male connector having a first pin-out 72, a second pin-out 74, a third pin-out 76, and a fourth pin-out 78. It is understood that the fourth connector 70 may be any conventional connector for providing electrical communication and may further include an internal circuit for routing an electrical current to a desired conductive path.

In FIG. 1, the fourth connector first pin-out 72 is in electrical communication with the third connector first pin-out 62; the fourth connector second pin-out 74 is in electrical communication with the third connector second pin-out 64; the fourth connector third pin-out 76 is in electrical communication with the third connector third pin-out 66; and the fourth connector fourth pin-out 78 in electrical communication with the third connector fourth pin-out 68. In FIG. 2, the fourth connector first pin-out 72 is in electrical communication with the first connector first pin-out 38; the fourth connector second pin-out 74 is in electrical communication with the first connector second pin-out 40; the fourth connector third pin-out 76 is in electrical communication with the first connector third pin-out 42; and the fourth connector fourth pin-out 78 is in electrical communication with the first connector fourth pin-out of the first connector 44. It is understood that the fourth connector 70 may have any pin-out configuration, as desired. It is further understood that the controller 16 may be adapted to provide electrical energy to the lighting system 10.

In use, the first connector 24 is coupled to the second connector 50 and the third connector 52 is coupled to the fourth connector 70 as shown in FIG. 1. The controller 16 provides electrical current to the second lighting module supply path 46 through the fourth connector first pin-out 72, the fourth connector first pin-out 72 in electrical communication with the third connector first pin-out 62. The current flows through the third connector first pin-out 62 and the second lighting module supply path 46, the second lighting module supply path 46 in electrical communication with the second connector fourth pin-out 60. The current then flows through the second connector fourth pin-out 60 into the first connector fourth pin-out 44. The current flows from the first connector fourth pin-out 44 through the first lighting module supply path 34. As shown, the current returns to the controller 16 through the parallel return paths 36, 48 of the red LEDs 28, the blue LEDs 32, and the green LEDs 30. The current flowing through the return paths 36, 48 illuminates the light source 20, the light source 20 emitting light. The current flows through the diode 26 in forward bias with the first lighting module return path 36 of the red LED 28, the diode 26 allowing current to flow in the desired return direction.

FIG. 2 shows an improper connection of the lighting system 10. As shown, the first connector 24 is coupled to the fourth connector 70. The controller 16 provides electrical current to the fourth connector first pin-out 72, the fourth connector first pin-out 72 in electrical communication with the first connector first pin-out 38. Since the first connector pin-outs 38, 40, 42, 44 are not properly associated with the fourth connector pin-outs 72, 74, 76, 78, the current begins to flow in a reverse bias direction along the first lighting module return path 36 of the red LED 28. The diode 26 militates against the reverse bias current flowing in an undesirable direction and further militates against damage to the light sources 20 of the first lighting module 12. The light sources 20 do not function, and the user may adjust the improper connection.

The lighting system 10 and method provide a simplified, standardized, and inexpensive means of polarized electrical connection for a string of light sources 20. Typically, connector polarization is accomplished by mechanical means which drives up the complexity, difficulty, and cost of manufacturing. The lighting system 10 and method according to the present invention provide an electronic means of circuit protection to militate against damage caused by improper electrical connection, thereby providing a simple means of polarized connection.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A lighting module comprising:
a light source;
a connector adapted to provide electrical communication with a source of electrical energy;
a conductive path including a supply path and a plurality of return paths, the conductive path providing electrical communication between the light source and the connector; and
a diode disposed in at least one of the return paths, wherein the diode militates against a current flowing in an undesirable direction.

2. The lighting module according to claim 1, wherein the light source is an LED package.

3. The lighting module according to claim 1, wherein the supply path is in electrical communication with the source of electrical energy.

4. The lighting module according to claim 1, wherein the lighting module is in electrical communication with another lighting module.

5. The lighting module according to claim 1, wherein the lighting module is in electrical communication with a controller.

6. The lighting module according to claim 1, wherein the connector includes a plurality of internal circuits routing an electrical current to the conductive path.

7. The lighting module according to claim 1, wherein the connector includes a plurality of connector pin-outs, the connector pin-outs providing a means for electrical communication with the conductive path.

8. A lighting system comprising:
a lighting module further comprising:
a substrate;
a light source disposed on the substrate;
a first connector adapted to provide electrical communication with a source of electrical energy;
a conductive path including a supply path and a plurality of return paths, the conductive path providing electrical communication between the light source and the connector; and
a diode disposed in at least one of the return paths, wherein the diode militates against a current flowing in an undesirable direction; and
a controller having a second connector adapted to provide electrical communication with the lighting module.

9. The lighting system according to claim 8, wherein the light source is an LED package.

10. The lighting system according to claim 8, wherein the controller provides a source of electrical energy.

11. The lighting system according to claim 8, wherein the supply path is in electrical communication with the source of electrical energy.

12. The lighting system according to claim 8, wherein the first connector and the second connector each includes a plurality of internal circuits for routing an electrical current to the conductive path.

13. The lighting system according to claim 8, wherein the first connector includes a plurality of connector pin-outs, the connector pin-outs providing a means for electrical communication with the conductive path.

14. A lighting system comprising:
a first lighting module including a substrate, a light source disposed on the substrate, a first connector adapted to provide electrical communication with a second lighting module, a conductive path including a supply path and a plurality of return paths, the conductive path providing electrical communication between the light source and the connector, and a diode disposed in at least one of the return paths, wherein the diode militates against a current flowing in an undesirable direction;
a second lighting module including a substrate, a light source disposed on the substrate, a second connector adapted to provide electrical communication with the first connector of the first lighting module, a third connector adapted to provide electrical communication with a controller, a plurality of conductive paths including a supply path and a plurality of return paths, the conductive paths providing electrical communication between the light source and the second and third connectors; and
a controller having a fourth connector adapted to provide electrical communication with the third connector of the second lighting module;

15. The lighting system according to claim 14, wherein the light source is an LED package.

16. The lighting system according to claim 14, wherein the controller provides a source of electrical energy.

17. The lighting system according to claim 14, wherein the supply path is in electrical communication with the source of electrical energy.

18. The lighting system according to claim 14, wherein the first connector and the second connector each includes a plurality of internal circuits for routing an electrical current to the conductive path.

19. The lighting system according to claim 14, wherein the first connector includes a plurality of connector pin-outs, the connector pin-outs providing a means for electrical communication with the conductive path.

20. The lighting system according to claim 14, wherein the third connector includes a plurality of connector pin-outs, the connector pin-outs providing a means for electrical communication with the conductive paths of the second lighting module.
